(19) United States
(12) Patent Application Publication
(10) Pub. No.: US 2008/0008261 A1
(43) Pub. Date: Jan. 10, 2008

(54) Method for Signal Processing and a Signal Processor in an Ofdm System

(75) Inventors: Constant Paul Marie Jozef Baggen, Eindhoven (NL); Sri Andari Husen, Eindhoven (NL); Maurice Leonardus Anna Stassen, Eindhoven (NL); Hoi Yip Tsang, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,596

(22) PCT Filed: May 20, 2005
(86) PCT No.: PCT/IB05/51652

§ 371 Date: Aug. 1, 2007

(30) Foreign Application Priority Data
May 28, 2004 (EP) 04102370.6

(51) Int. Cl. H04L 25/03; H04J 11/00

(52) U.S. Cl. 375/296; 370/210; 375/346

(57) ABSTRACT

A method of signal processing and a signal processor for a receiver for OFDM encoded digital signals. OFDM encoded digital signals are transmitted as data symbol sub-carriers in several frequency channels. A subset of the sub-carriers is in the form of pilot sub-carriers having a pilot value (aₚ) known to the receiver. The method comprises estimation of a channel transfer function (H) and a derivative of the channel transfer function (H′) by means of a channel estimation scheme from a received signal (y). Then, an estimation of data (a) is performed from the received signal (y) and the channel transfer function (H). Finally, an estimation of a cleaned received signal (y₂) is performed from the data (a), the derivative of the channel transfer function (H′) and the received signal (y) by removal of inter-carrier interference (ICI), by taking into account at least one of a previous and a future OFDM symbol, followed by an iteration of the above-mentioned estimations.

The present invention relates to a method of processing OFDM encoded digital signals in a communication system and a corresponding signal processor.

The invention also relates to a receiver arranged to receive OFDM encoded signals and to a mobile device that is arranged to receive OFDM encoded signals. Finally, the invention relates to a telecommunication system comprising such mobile device. The method may be used for deriving improved data estimation in a system using OFDM technique with pilot sub-carriers, such as a terrestrial video broadcasting system DVB-T, or DVB-H. A mobile device can e.g. be a portable T.V., a mobile phone, a PDA (personal digital assistant) or e.g. a portable PC (labtop), or any combination thereof.

In wireless systems for the transmission of digital information, such as voice and video signals, orthogonal frequency division multiplexing technique (OFDM) has been widely used. OFDM may be used to cope with frequency-selective fading radio channels. Interleaving of data may be used for efficient data recovery and use of data error correction schemes.

OFDM is today used in for example the Digital Audio Broadcasting (DAB) system Eureka 147 and the Terrestrial Digital Video Broadcasting system (DVB-T). DVB-T supports 5-30 Mbps net bit rate, depending on modulation and coding mode, over 8 MHz bandwidth. For the 8K mode, 6817 sub-carriers (of a total of 8192) are used with a sub-carrier spacing of 1116 Hz. OFDM symbol useful time duration is 896 μs and OFDM guard interval is ¼, ⅛, 1/16 or 1/32 of the time duration.

However, in a mobile environment, such as a car or a train, the channel transfer function as perceived by the receiver varies as a function of time. Such variation of the transfer function within an OFDM symbol may result in inter-carrier interference, ICI, between the OFDM sub-carriers, such as a Doppler broadening of the received signal. The inter-carrier interference increases with increasing vehicle speed and makes reliable detection above a critical speed impossible without countermeasures.

A signal processing method is previously known from WO 02/067525, WO 02/067526 and WO 02/067527, in which a signal a as well as a channel transfer function H and the time derivative thereof H′ of an OFDM symbol are calculated for a specific OFDM symbol under consideration.

Moreover, U.S. Pat. No. 6,654,429 discloses a method for pilot-added channel estimation, wherein pilot symbols are inserted into each data packet at known positions so as to occupy predetermined positions in the time-frequency space. The received signal is subject to a two-dimensional inverse Fourier transform, two-dimensional filtering and a two-dimensional Fourier transform to recover the pilot symbols so as to estimate the channel transfer function.

An object of the present invention is to provide a method for signal processing which is less complex.

A further object of the present invention is to provide a method for signal processing for estimation of a channel transfer function, in which the estimation is further improved by removal of pilot-induced interference.

These and other objects are met by a method of processing OFDM encoded digital signals, wherein said OFDM encoded digital signals are transmitted as data symbol sub-carriers in several frequency channels, a subset of said sub-carriers being in the form of pilot sub-carriers having a known pilot value. The method comprises: estimation of a channel transfer function and a derivative of the channel transfer function by means of a channel estimation scheme from a signal; estimation of data from said received signal and said channel transfer function; estimation of a cleaned signal from said data, said derivative of the channel transfer function and said signal by removal of inter-carrier interference, by taking into account at least one of a past and a future OFDM symbol, and iteration of the above-mentioned estimations. In this way, an efficient method of estimation of the data is obtained.

Said estimation of data may be performed by a set of M-tap equalizers. Such equalizers may be recalculated for each iteration. The number of taps for the equalizers may be 1 and 3, and the number of iterations may be two for 1-tap equalizers and one for 3-tap equalizers.

In an embodiment of the invention, pilot-induced inter-carrier interference is removed by using said derivative of the channel transfer function (H′) and said known pilot values (aₚ).

In another embodiment of the invention, the pilot values are removed from said received signal by the following formula:
y_{1,p}=y_{0,p}−Hₚaₚ
where p is the index of said pilot sub-carrier.

In still another embodiment of the invention, the method further comprises: removing said inter-carrier interference by the formula:
y₃=y₁− [symbol] ·diag(Ĥ′₁)·â₁
where: [symbol]
is an inter-carrier interference spreading matrix, which may be defined by the formula:

$${Ξ}_{m , k} = \frac{1}{{N}^{2} \cdot {f}_{s}} {\sum }_{i = 0}^{N - 1} ( i - δ ) {ⅇ}^{- j \frac{2 π ( m - k ) i}{N}} , δ = \frac{N - 1}{2} , 0 \leq k < N$$

where N is number of sub-carriers and fₛ is sub-carrier spacing.

In order to reduce the complexity of calculations, the interference spreading matrix may be a band matrix defined by the following formula: [symbol]
=0 for |m−k|>L/2, 0≦m<N, 0≦k<N

In a further embodiment of the invention, the product of the channel transfer function (H) and said data (a) is filtered by a filter having L taps, and filter coefficients [ [symbol] . . . [symbol] ], and the sum of the filter is subtracted from said received signal in order to provide a cleaned received signal.

In another aspect of the invention, it comprises a signal processor for performing the above-mentioned method steps.

Further objects, features and advantages of the invention will become evident from a reading of the following description of an exemplifying embodiment of the invention with reference to the appended drawings, in which:

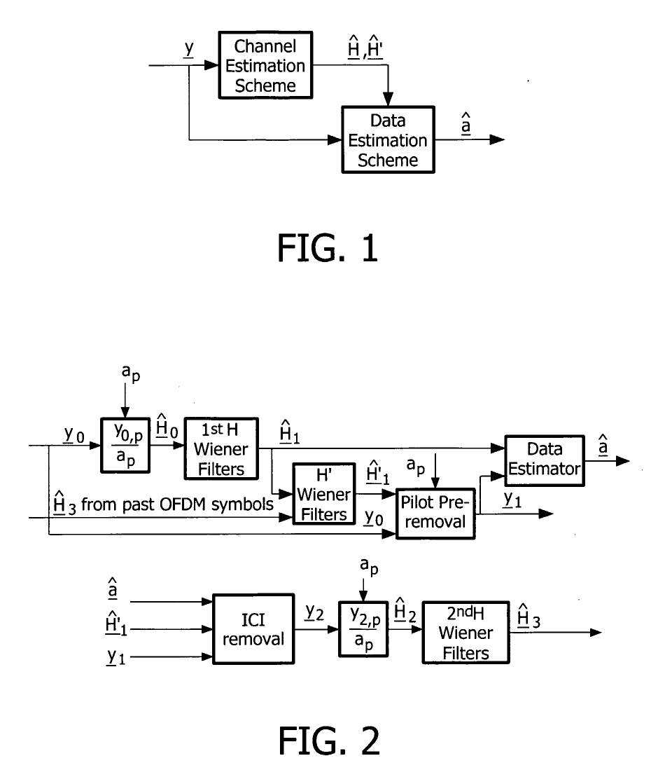

FIG. 1 is a schematic block diagram showing a general signal processing framework of the present invention;

FIG. 2 is a schematic block diagram of a complete channel estimation scheme in which the invention may be used;

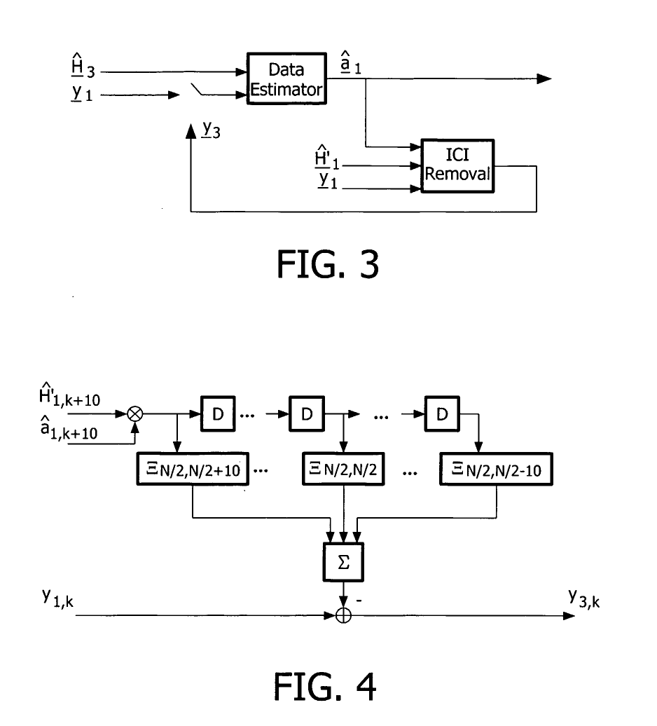

FIG. 3 is a schematic block diagram showing a data estimation scheme;

FIG. 4 is a schematic block diagram showing simplified removal of inter-carrier interference according to the invention.

In a mobile environment, due to vehicle movement, the channel seen by the receiver is varying over time. In DVB-T system, which uses OFDM, this variation leads to the occurrence of Inter-Carrier Interference (ICI). The ICI level increases with the increase of the vehicle speed. For reception in fast moving vehicle, special counter measures must be taken to achieve reliable detection.

The general framework to achieve reliable detection is shown in FIG. 1. The data estimation scheme compensates the distortions in the received signal and estimates the transmitted symbols from it. For these purposes, the data estimation scheme needs the channel parameters, which are estimated by a channel estimation scheme.

A complete scheme for channel estimation is shown in FIG. 2.

The channel estimation scheme is based on the following channel model. For all reasonable vehicle speed, the received signal in frequency domain can be approximated as follows.

$$\begin{matrix}\underline{y} \approx diag \{ \underline{H} \} \cdot \underline{a} + Ξ \cdot diag \{ {\underline{H}}^{′} \} \cdot \underline{a} + \underline{n} & ( 1 ) \\ {Ξ}_{m , k} = \frac{1}{{N}^{2} \cdot {f}_{s}} {\sum }_{i = 0}^{N - 1} ( i - δ ) {ⅇ}^{- j \frac{2 π ( m - k ) i}{N}} , δ = \frac{N - 1}{2} , 0 \leq k < N & ( 2 )\end{matrix}$$

with:
y: the received signal
H: the complex channel transfer function vector for all the sub-carriers
H′: the temporal derivative of H
[symbol] : the fixed ICI spreading matrix
a: the transmitted symbols vector
n: a complex circular white Gaussian noise vector
N: number of sub-carriers
ƒₛ: sub-carrier spacing

In the present invention, the problem of how to estimate the transmitted data is solved, given the received signal and the estimated channel parameters H and H′ from the channel estimation scheme.

A possible solution is to use an N-tap equalizer for each data sub-carrier to obtain an estimate of the transmitted symbol. The equalizer is designed such that the estimated error is minimized in the mean-square sense. However, in the present invention, there is disclosed a data estimation scheme with reduced complexity.

The proposed iterative data estimation scheme is depicted in FIG. 3. This scheme consists of two blocks, namely a data estimator in the feed-forward path and an ICI removal block in the feedback path. At the first iteration, the data estimator is fed with the output of pilot pre-removal from the channel estimator y₁. If no iteration is imposed, the output of the data estimator â₁ is the output of the scheme, which will further be fed into the slicer. If there is iteration, â₁ is fed into the ICI removal block, which takes also Ĥ₁ and yₚ, to produce a cleaner received signal y₃·y₃ is then fed into data estimator to produce better data estimates â₁. The mechanism will go on up to the imposed number of iterations.

The data estimator is a set of M-tap equalizers. In every iteration, the equalizers are recalculated because y₃ has less ICI after every iteration. The suggested numbers of tap for the equalizers are 1 and 3. For the 1-tap case, the suggested number of iterations is 2, while for the 3-tap case, the suggested number of iterations is one.

The calculation to obtain the equalizer coefficients for the first iteration is explained as follows. Firstly, equation (1) is rewritten.
y≈C·a+n (3)
with:
C=diag{H}+ [symbol] ·diag{H′} (4)

The 1-tap equalizer applies to sub-carrier k is calculated using the Wiener principle as follows:

$$\begin{matrix}E [ ( {a}_{k} - {\hat{a}}_{k} ) {y}_{k}^{*} = 0 \\ E [ {a}_{k} {y}_{k}^{*} ] = E [ {\hat{a}}_{k} {y}_{k}^{*} ] \\ E [ {a}_{k} {\sum }_{i = 1}^{N} {C}_{k , i}^{*} {a}_{i}^{*} ] = E [ {w}_{k} {y}_{k} {y}_{k}^{*} ] \\ \begin{matrix}{w}_{k} = \frac{{C}_{k , k}^{*} \cdot E [ {a}_{k} {a}_{k}^{*} ]}{E [ {y}_{k} {y}_{k}^{*} ]} \\ = \frac{{C}_{k , k}^{*} \cdot E [ {a}_{k} {a}_{k}^{*} ]}{{\sum }_{i = 1}^{N} {\vert {C}_{k , i} \vert}^{2} E [ {a}_{i} {a}_{i}^{*} ] + {σ}_{n}^{2}} \\ = \frac{{C}_{k , k}^{*} \cdot E [ {a}_{k} {a}_{k}^{*} ]}{{\vert {C}_{k , k} \vert}^{2} E [ {a}_{k} {a}_{k}^{*} ] + {\sum }_{i = 1 , i \neq k}^{N} {\vert {C}_{k , i} \vert}^{2} E [ {a}_{i} {a}_{i}^{*} ] + {σ}_{n}^{2}} \\ = \frac{{C}_{k , k}^{*} \cdot E [ {a}_{k} {a}_{k}^{*} ]}{{\vert {H}_{k} \vert}^{2} E [ {a}_{k} {a}_{k}^{*} ] + {\sum }_{i = 1 , i \neq k}^{N} {\vert {Ξ}_{k , i} \vert}^{2} {\vert {H}_{i}^{′} \vert}^{2} E [ {a}_{i} {a}_{i}^{*} ] + {σ}_{n}^{2}} \\ = \frac{{H}_{k}^{*} \cdot E [ {a}_{k} {a}_{k}^{*} ]}{{\vert {H}_{k} \vert}^{2} \cdot E [ {a}_{k} {a}_{k}^{*} ] + {σ}_{ICI , k}^{2} + {σ}_{n}^{2}}\end{matrix} & ( 5 ) \\ with & \\ {σ}_{ICI , k}^{2} = {\sum }_{i = 1 , i \neq k}^{N} {\vert {Ξ}_{k , i} \vert}^{2} {\vert {H}_{i}^{′} \vert}^{2} \cdot E [ {a}_{i} {a}_{i}^{*} ] & ( 6 ) \\ {\hat{a}}_{k} = {w}_{k} {y}_{k} & ( 7 ) \\ {ɛ}_{k} = E [ {\vert {a}_{k} - {\hat{a}}_{k} \vert}^{2} ] = E [ {a}_{k} {a}_{k}^{*} ] \cdot ( 1 - {H}_{k} {w}_{k} ) \\ E [ {a}_{k} {a}_{k}^{*} ] = 1 \\ E [ {a}_{i} {a}_{i}^{*} ] = \{ \begin{matrix}1 & i is data sub \text{-} carrier \\ 0 & i is pilot sub \text{-} carrier\end{matrix} & ( 8 )\end{matrix}$$

The calculation of ICI power at each sub-carrier requires 3N multiplication (apart from the squaring operation). This can be further simplified as follows:

$${σ}_{ICI , k}^{2} \approx {\vert {H}_{k}^{′} \vert}^{2} {\sum }_{i = 1 , i \neq k}^{N} {\vert {Ξ}_{k , i} \vert}^{2} E [ {a}_{i} {a}_{i}^{*} ] \approx {\vert {H}_{k}^{′} \vert}^{2} 6.0843 \cdot {10}^{- 8} \qquad ( 9 )$$

for the 8k DVB-T mode.

The summation is pre-calculated. The value showed in equation (9) is the average of the summation calculated in the middle of the frequency band. This calculation reduces the complexity to 2 multiplications per sub-carrier.

For the 1^{st} iteration, the term σ_{ICI,k}² needs recalculation. It is approximated as follows:

$${σ}_{ICI , k}^{2} \approx {\sum }_{i = 1 , i \neq k}^{N} {\vert {Ξ}_{k , i} \vert}^{2} {\vert {H}_{i}^{′} \vert}^{2} \cdot E [ {\vert {a}_{i} - {\hat{a}}_{i} \vert}^{2} ] \approx {\vert {H}_{k}^{′} \vert}^{2} \cdot {ɛ}_{k} {\sum }_{i = 1 , i \neq k}^{N} {\vert {Ξ}_{k , i} \vert}^{2} \qquad ( 10 )$$

Hence the equalizer coefficient for sub-carrier k is

$$\begin{matrix}{w}_{k}^{( 1 )} \approx \frac{{C}_{k , k}^{*} \cdot E [ {a}_{k} {a}_{k}^{*} ]}{{\vert {H}_{k} \vert}^{2} E [ {a}_{k} {a}_{k}^{*} ] + {\vert {H}_{k}^{′} \vert}^{2} {ɛ}_{k} {\sum }_{i = 1 , i \neq k}^{N} {\vert {Ξ}_{k , i} \vert}^{2} + {σ}_{n}^{2}} & ( 11 ) \\ {ɛ}_{k}^{( 1 )} = E [ {\vert {a}_{k} - {\hat{a}}_{k} \vert}^{2} ] = E [ {a}_{k} {a}_{k}^{*} ] \cdot ( 1 - {H}_{k} {w}_{k}^{( 1 )} ) & ( 12 ) \\ For the {n}^{th} iteration , the coefficient and the MSE are & \\ {w}_{k}^{( n )} \approx \frac{{C}_{k , k}^{*} \cdot E [ {a}_{k} {a}_{k}^{*} ]}{{\vert {H}_{k} \vert}^{2} E [ {a}_{k} {a}_{k}^{*} ] + {\vert {H}_{k}^{′} \vert}^{2} {ɛ}_{k}^{( n - 1 )} {\sum }_{i = 1 , i \neq k}^{N} {\vert {Ξ}_{k , i} \vert}^{2} + {σ}_{n}^{2}} & ( 13 ) \\ {ɛ}_{k}^{( n )} = E [ {\vert {a}_{k} - {\hat{a}}_{k} \vert}^{2} ] = E [ {a}_{k} {a}_{k}^{*} ] \cdot ( 1 - {H}_{k} {w}_{k}^{( n )} ) & ( 14 )\end{matrix}$$

The above calculations are based on the assumption that H and H′ are perfectly known. For estimated H and H′, two additional factors must be added to the denominator of Equations (5), (11), and (13), namely γₗₗ being the MSE of the 2^{nd} H Wiener Filter

$${\sum }_{i = 1}^{N} {\vert {Ξ}_{k , i} \vert}^{2} {γ}_{{II}^{′}} E [ {a}_{i} {a}_{i}^{*} ] \approx {γ}_{{II}^{′}} {\sum }_{i = 1}^{N} {\vert {Ξ}_{k , i} \vert}^{2} E [ {a}_{i} {a}_{i}^{*} ] \approx {γ}_{{II}^{′}} 6.0843 \cdot {10}^{- 8} , with {γ}_{{II}^{′}}$$

being the MSE of the H′ Wiener filter.

The general N-tap optimum Wiener Equalizer is as follows:
â=W·y (15)
W=E[aa^{ll}]·C^{ll}·(C·E[aa^{ll}]·C^{ll}+σₙ²I_{N})⁻¹ (16)
W is a N×N matrix. Row k corresponds to the N-tap equalizer for sub-carrier k.

The calculation of W requires 4 matrix multiplications and a N×N matrix inversion. This complexity is beyond what can normally be handled in practical implementation. In the following part, the complexity is reduced by using M-tap equalizer instead of N, M<<N and by reducing the number of multiplications.

The M-tap symmetric Wiener equalizer for sub-carrier k is calculated as follows:

The orthogonality principle:

$$\begin{matrix}E [ ( {a}_{k} - {\hat{a}}_{k} ) {y}_{k - L}^{*} = 0 \\ ⋮ \\ E [ ( {a}_{k} - {\hat{a}}_{k} ) {y}_{k + L}^{*} = 0\end{matrix} \\ with \text{:} \\ L = ⌊ M / 2 ⌋ \\ {\hat{a}}_{k} = {\sum }_{l = - L}^{L} {W}_{k , l} {y}_{k - l} \qquad ( 17 )$$

Following the same derivation, we arrive at:

$$[ \begin{matrix}E [ {a}_{k} {\sum }_{i = 1}^{N} {C}_{k - L , i}^{*} {a}_{i}^{*} ] \\ ⋮ \\ E [ {a}_{k} {\sum }_{i = 1}^{N} {C}_{k + L , i}^{*} {a}_{i}^{*} ]\end{matrix} ] = [ \begin{matrix}E [ {\sum }_{l = - L}^{L} {W}_{k , l} {y}_{k - l} {y}_{k - L}^{*} ] \\ ⋮ \\ E [ {\sum }_{l = - L}^{L} {W}_{k , l} {y}_{k - l} {y}_{k + L}^{*} ]\end{matrix} ] \\ \begin{matrix}[ \begin{matrix}E [ {a}_{k} {a}_{k}^{*} ] {C}_{k + L , k}^{*} \\ ⋮ \\ E [ {a}_{k} {a}_{k}^{*} ] {C}_{k - L , k}^{*}\end{matrix} ] = \\ [ [ \begin{matrix}{\sum }_{i = 1}^{N} {C}_{k + L , i} {C}_{k + L , i}^{*} \cdot E [ {a}_{i} {a}_{i}^{*} ] & … & {\sum }_{i = 1}^{N} {C}_{k - L , i} {C}_{k + L , i}^{*} \cdot E [ {a}_{i} {a}_{i}^{*} ] \\ ⋮ & ⋰ & ⋮ \\ {\sum }_{i = 1}^{N} {C}_{k + L , i} {C}_{k - L , i}^{*} \cdot E [ {a}_{i} {a}_{i}^{*} ] & … & {\sum }_{i = 1}^{N} {C}_{k - L , i} {C}_{k - L , i}^{*} \cdot E [ {a}_{i} {a}_{i}^{*} ]\end{matrix} ] + {σ}_{n}^{2} {I}_{M} ] \\ [ \begin{matrix}{W}_{k , - L} \\ ⋮ \\ {W}_{k , + L}\end{matrix} ]\end{matrix} \\ \begin{matrix}[ \begin{matrix}{W}_{k , - L} \\ ⋮ \\ {W}_{k , + L}\end{matrix} ] = \\ {[ [ \begin{matrix}{\sum }_{i = 1}^{N} {C}_{k + L , i} {C}_{k + L , i}^{*} \cdot E [ {a}_{i} {a}_{i}^{*} ] & … & {\sum }_{i = 1}^{N} {C}_{k - L , i} {C}_{k + L , i}^{*} \cdot E [ {a}_{i} {a}_{i}^{*} ] \\ ⋮ & ⋰ & ⋮ \\ {\sum }_{i = 1}^{N} {C}_{k + L , i} {C}_{k - L , i}^{*} \cdot E [ {a}_{i} {a}_{i}^{*} ] & … & {\sum }_{i = 1}^{N} {C}_{k - L , i} {C}_{k - L , i}^{*} \cdot E [ {a}_{i} {a}_{i}^{*} ]\end{matrix} ] + {σ}_{n}^{2} {I}_{M} ]}^{- 1} \\ [ \begin{matrix}E [ {a}_{k} {a}_{k}^{*} ] {C}_{k + L , k}^{*} \\ ⋮ \\ E [ {a}_{k} {a}_{k}^{*} ] {C}_{k - L , k}^{*}\end{matrix} ]\end{matrix} \\ with E [ {a}_{k} {a}_{k}^{*} ] = 1 \qquad ( 18 )$$

To reduce the computation, we approximate the summations as follows:

$$\begin{matrix}\begin{matrix}{\sum }_{i = 1}^{N} {C}_{k + l , i} {C}_{k + l , i}^{*} \cdot E [ {a}_{i} {a}_{i}^{*} ] = {\vert {H}_{k + I} \vert}^{2} \cdot E [ {a}_{k + 1} {a}_{k + I}^{*} ] + \\ \vert {H}_{k + I}^{′} \vert {\sum }_{i = 1 , 1 \neq k + l}^{N} {\vert {Ξ}_{k + l , i} \vert}^{2} E [ {a}_{i} {a}_{i}^{*} ] \\ = {\vert {H}_{k + I} \vert}^{2} \cdot E [ {a}_{k + 1} {a}_{k + I}^{*} ] + {\vert {H}_{k + I}^{′} \vert}^{2} \cdot \\ 6.0843 \cdot {10}^{- 8} , l ∈ [ - L , L ]\end{matrix} & ( 19 ) \\ with \text{:} & \\ E [ {a}_{i} {a}_{i}^{*} ] = \{ \begin{matrix}1 & i is data sub \text{-} carrier \\ 0 & i is pilot sub \text{-} carrier\end{matrix} & ( 20 ) \\ E [ {a}_{k + l} {a}_{k + l}^{*} ] = \{ \begin{matrix}1 & k + l is data sub \text{-} carrier \\ 16 / 9 & k + l is pilot sub \text{-} carrier\end{matrix} & ( 21 ) \\ \begin{matrix}{\sum }_{i = 1}^{N} {C}_{k + l - p , i} {C}_{k + l , i}^{*} \cdot E [ {a}_{i} {a}_{i}^{*} ] \approx E [ {a}_{k + l - p} {a}_{k + l - p}^{*} ] \cdot \\ {H}_{k + l - p} ( {H}_{k + l}^{′ *} {Ξ}_{k + l , k + l - p}^{*} ) + E [ {a}_{k + l} {a}_{k + l}^{*} ] \cdot {H}_{k + l}^{*} ( {H}_{k + l - p}^{′} {Ξ}_{k + l - p , k + l} ) + \\ {H}_{k + l - p}^{′ *} {H}_{k + l}^{′ *} {\sum }_{i = 1 , i \neq k + l , i \neq k + l - p}^{N} {Ξ}_{k + l - p , i} {Ξ}_{k + l , i}^{*} \cdot E [ {a}_{i} {a}_{i}^{*} ] \\ for l ∈ [ - L , L ] and p ∈ [ 0 , - 2 L ]\end{matrix} & ( 22 ) \\ with \text{:} & \\ E [ {a}_{k + l - p} {a}_{k + l - p}^{*} ] = \{ \begin{matrix}1 & k + l - p is data sub \text{-} carrier \\ 16 / 9 & k + l - p is pilot sub \text{-} carrier\end{matrix} & ( 23 )\end{matrix}$$

Note that [symbol] =( [symbol] )*, due to the Hermitian property of Ξ matrix. Furthermore, because the [symbol] matrix a Toeplitz matrix, for a certain p, [symbol] = [symbol] , for all (k,l). The summation

$${\sum }_{i = 1 , i \neq k + l , i \neq k + l - p}^{N} {Ξ}_{k + l - p , i} {Ξ}_{k + l , i}^{*} \cdot E [ {a}_{i} {a}_{i}^{*} ]$$

therefore can be pre-calculated for all p.

It is also noteworthy that the matrix under inversion is Hermitian, i.e.

$${\sum }_{i = 1}^{N} {C}_{k - l , i} {C}_{k + l , i}^{*} \cdot E [ {a}_{i} {a}_{i}^{*} ] = {( {\sum }_{i = 1}^{N} {C}_{k + l , i} {C}_{k - l , i}^{*} \cdot E [ {a}_{i} {a}_{i}^{*} ] )}^{*} ,$$

therefore only the upper or lower triangle needs to be calculated. The rest is obtained by taking the conjugate of the triangle.

An additional operation may be performed prior to the first data estimation (see patent application filed concurrently herewith with reference ID696812, the contents of which is incorporated in the present specification by reference) in order to ensure the whiteness of the residual ICI plus noise process at the input of second H filters, namely, the removal of pilot-induced ICI from the received signal. This operation uses Ĥ′₁ and the known pilot symbols aₚ to regenerate the ICI caused by the pilot symbols on all sub-carriers and subsequently cancels it from y₀.

Since the pilot symbols are known, they can be removed from the received signal, i.e.:
y_{1,p}=y_{0,p}−Hₚaₚ, p is index of pilot sub-carrier (b 24)

For M-tap equalizers, this operation is advantageous to the sub-carriers next to the pilots, i.e. at index p+1 and p−1, because the interference from the two sub-carriers will be the strongest in the absence of the pilot and therefore the equalizers at both sub-carriers can gain extra information from the remaining signal at the pilot. Note that because of this operation, equations (21) and (23) must be modified: for all pilot sub-carriers, the average power is zero.

The operation performed in the ICI removal is as follows:
y₃=y₁− [symbol] ·diag(Ĥ′₁)·â₁ (25)

If it is done in a conventional way, this operation requires N(N+1) multiplications, or (N+1) multiplications per sub-carrier.

The suggestion according to the present invention is as follows. Because the significant values of [symbol] are concentrated along the main diagonal, for each sub-carrier, instead of canceling interference originated from all sub-carriers, we cancel only the interference originated from a number of the closest sub-carriers. Furthermore, because Ξ is a Toeplitz matrix, the elements along each of the diagonals have the same value. This means for all sub-carriers the elements involved in the cancellation are the same. Therefore the multiplication operation can be viewed as the filtering of the element-product of Ĥ₁ and â₁, with L-tap filter, whose coefficients are [ [symbol] . . . , [symbol] ]. The number of multiplication per sub-carrier is L+1.

FIG. 4 shows the simplified operation.

The invention can generally be applied to any OFDM system with a pilot structure and suffering from ICI.

The different filters and operations may be performed by a dedicated digital signal processor (DSP) and in software. Alternatively, all or part of the method steps may be performed in hardware or combinations of hardware and software, such as ASIC:s (Application Specific Integrated Circuit), PGA (Programmable Gate Array), etc.

It is mentioned that the expression “comprising” does not exclude other elements or steps and that “a” or “an” does not exclude a plurality of elements. Moreover, reference signs in the claims shall not be construed as limiting the scope of the claims.

Herein above has been described several embodiments of the invention with reference to the drawings. A skilled person reading this description will contemplate several other alternatives and such alternatives are intended to be within the scope of the invention. Also other combinations than those specifically mentioned herein are intended to be within the scope of the invention. The invention is only limited by the appended patent claims.

1. A method of processing OFDM encoded digital signals, wherein said OFDM encoded digital signals are transmitted as data symbol sub-carriers in several frequency channels, a subset of said sub-carriers being pilot sub-carriers having a known pilot value (aₚ), comprising:
estimating a channel transfer function (H) and a derivative of the channel transfer function (H′) by means of a channel estimation scheme from a received signal (y);
estimating data (a) from said received signal (y) and said channel transfer function (H);
estimating a cleaned received signal (y₂) from said data (a), said derivative of the channel transfer function (H′) and said received signal (y) by removal of inter-carrier interference, by taking into account at least one of a past and a future OFDM symbol; and
iterating the above-mentioned estimations.

2. The method of claim 1, wherein said estimating data (a) is performed by a set of M-tap equalizers.

3. The method of claim 2, wherein said equalizers are recalculated for each iteration.

4. The method of claim 2, wherein a number of taps for the equalizers is 1 or 3, and a number of iterations is two for 1-tap equalizers and one for 3-tap equalizers.

5. The method of claim 1, further comprising removal of pilot-induced intercarrier interference by using said derivative of the channel transfer function (H′) and said known pilot values (aₚ).

6. The method of claim 1, wherein said pilot values (aₚ) are removed from said received signal (y) by the formula:
y_{1,p}=y_{0,p}−Hₚaₚ
where p is an index of said pilot sub-carrier.

7. The method of claim 1, further comprising:
removing said inter-carrier interference by the formula:
y₃=y₁− [symbol] ·diag(Ĥ₁)·â₁
where:
Ξ is an inter-carrier interference spreading matrix.

8. The method of claim 7, wherein
$${Ξ}_{m , k} = \frac{1}{{N}^{2} \cdot {f}_{s}} {\sum }_{i = 0}^{N - 1} ( i - δ ) {ⅇ}^{- j \frac{2 π ( m - k ) i}{N}} , δ = \frac{N - 1}{2} , 0 \leq k < N$$
where N is number of sub-carriers and fₛ is sub-carrier spacing.

9. The method of claim 8, wherein the interference spreading matrix is a band matrix defined by: [symbol]
=0 for |m−k|>L/2, 0≦m<N, 0≦k<N

10. The method of claim 9, wherein a product of said channel transfer function (H) and said data (a) is filtered by a filter having L taps, and filter coefficients [ [symbol] . . . [symbol] ], and a sum of the filter is subtracted from said received signal (y) in order to provide a cleaned received signal (y₂).

11. A signal processor arranged to process OFDM encoded digital signals, wherein said OFDM encoded digital signals are transmitted as data symbol sub-carriers in several frequency channels, a subset of said sub-carriers being in the form of pilot sub-carriers having a known pilot value (aₚ), comprising:
a channel estimator arranged to estimate a channel transfer function (H) and a derivative of the channel transfer function (H′) by means of a channel estimation scheme from a signal (y);
a first data estimator arranged to estimate data (a) from said signal (y) and said channel transfer function (H);
a second data estimator arranged to estimate a cleaned received signal (y₂) from said data (a), said derivative of the channel transfer function (H′) and said received signal (y) by removal of inter-carrier interference, by taking into account at least one of a previous and a future OFDM symbol, and
means for iteration of the above-mentioned estimations.

12. A receiver arranged to receive OFDM encoded digital signals, wherein said OFDM encoded digital signals are transmitted as data sub-carriers in several frequency channels, a subset of said sub-carriers being in the form of pilot sub-carriers having a known pilot value, comprising:
a channel estimator arranged to estimate a channel transfer function (H) and a derivative of the channel transfer function (H′) by means of a channel estimation scheme from a signal (y);
a first data estimator arranged to estimate data (a) from said signal (y) and said channel transfer function (H);
a second data estimator arranged to estimate a cleaned received signal (y₂) from said data (a), said derivative of the channel transfer function (H′) and said received signal (y) by removal of inter-carrier interference, by taking into account at least one of a previous and a future OFDM symbol, and
means for iteration of the above-mentioned estimations.

13. A mobile device arranged to receive OFDM encoded digital signals, wherein said OFDM encoded digital signals are transmitted as data sub-carriers in several frequency channels, a subset of said sub-carriers being in the form of pilot sub-carriers having a known pilot value, comprising:
a channel estimator arranged to estimate a channel transfer function (H) and a derivative of the channel transfer function (H′) by means of a channel estimation scheme from a signal (y);
a first data estimator arranged to estimate data (a) from said signal (y) and said channel transfer function (H);
a second data estimator arranged to estimate a cleaned received signal (y₂) from said data (a), said derivative of the channel transfer function (H′) and said received signal (y) by removal of inter-carrier interference, by taking into account at least one of a previous and a future OFDM symbol, and
means for iteration of the above-mentioned estimations.

14. A mobile device arranged to receive OFDM encoded digital signals, wherein said OFDM encoded digital signals are transmitted as data sub-carriers in several frequency channels, a subset of said sub-carriers being in the form of pilot sub-carriers having a known pilot value, wherein the mobile device is arranged to carry out the method of claim 1.

15. A telecommunication system comprising a mobile device according to claim 13.
